(19) United States
(12) Patent Application Publication
(10) Pub. No.: US 2019/0240828 A1
(43) Pub. Date: Aug. 8, 2019

(54) TOOL BOX FOR OUTPUTTING INSTRUCTIONS FOR SERVICING AN IDENTIFIED TARGET DEVICE

(71) Applicant: Lenovo Enterprise Solutions (Singapore) Pte. Ltd., Singapore (SG)

(72) Inventors: Chang-Hsing Lee, New Taipei City (TW); Ming-Wang Tsai, Taipei City (TW); Chiung Wen Kuo, Taipei City (TW); Chiati Hsieh, New Taipei City (TW)

(21) Appl. No.: 16/202,480

(22) Filed: Nov. 28, 2018

(30) Foreign Application Priority Data
Feb. 6, 2018 (CN) 201810117827.9

(51) Int. Cl. B25H 3/02; G06F 3/14; G06F 3/16; G08B 5/36

(52) U.S. Cl. CPC B25H 3/021; G06F 3/14; G09B 19/003; G08B 5/36; G06F 3/16

(57) ABSTRACT

A tool box includes a base having a tool storage area for removably storing tools and a compartment below the tool storage area. The tool box further includes a lid selectively securable to the base in a closed position to secure the tools and releasable to an open position that provides user access to the tools. Still further, the tool box includes a processor and machine readable media storing instructions for performing a service operation with one or more of the tools, as well as a input device coupled to the processor, and an output device coupled to the processor for outputting at least a portion of the instructions to a user for servicing the target device. The input device is for receiving identification data and providing the identification data to the processor, wherein the identification data identifies a target device upon which the service operation is to be performed.

### CROSS-REFERENCE TO RELATED APPLICATIONS

This application claims priority under 35 U.S.C. § 119 to Chinese Patent Application No. 201810117827.9 filed Feb. 6, 2018, the entire text of which is specifically incorporated by reference herein.

### BACKGROUND

The present disclosure relates to a tool box containing tools for servicing a target device, such as computing device.

### BACKGROUND OF THE RELATED ART

When servicing or maintaining computing devices on site, one has to use different tools (e.g. screwdriver bits) which differ from one another in terms of type, shape or size. Each model of a server may require use of different tools, different screwdriver bits, or different steps of using the different tools or different screwdriver bits. It is time-consuming to navigate through a relevant user guide to identify the relevant instructions, steps and parts which may have to be replaced, and the selection and use of the correct tool is error-prone.

### BRIEF SUMMARY

One embodiment provides a tool box comprising a base having a tool storage area for removably storing a plurality of tools and a compartment below the tool storage area. The tool box further comprises a lid selectively securable to the base in a closed position to secure the plurality of tools and releasable to an open position that provides user access to the tools. Still further, the tool box comprises a processor and machine readable media storing instructions for performing a service operation with one or more of the tools, a data input device coupled to the processor, the data input device being for receiving identification data and providing the identification data to the processor, wherein the identification data identifies a target device upon which the service operation is to be performed, and an output device coupled to the processor for outputting at least a portion of the instructions to a user for servicing the target device.

Another embodiment provides a computer program product comprising non-transitory computer readable storage media having program instructions embodied therewith. The program instructions executable by a processor to: receive identification data through a data input device coupled to the processor, wherein the identification data identifies a target device upon which a service operation is to be performed; obtain instructions for performing the service operation on the identified target device; output at least a portion of the instructions to a user for servicing the target device; identify at least one tool that is identified in the portion of the instructions that is being output to the output device; and activate an indicator light that is viewable immediately adjacent one of a plurality of tools secured in a tool storage area of a tool box that incorporates the processor.

### BRIEF DESCRIPTION OF THE SEVERAL VIEWS OF THE DRAWINGS

FIG. 1A is a side view of a tool box according to an embodiment.

FIG. 1B is a top view of the tool box of FIG. 1.

FIG. 1C is another side view of the tool box of FIG. 1.

FIG. 2 is a diagram of a scanner in data communication with the tool box of FIG. 1 and obtaining identification data of a server to be serviced.

FIG. 3 is a perspective view of the tool box of FIG. 1 in conjunction with the scanner.

FIG. 4 is a display of the tool box of FIG. 1 displaying a user guide of a server to be serviced.

FIG. 5 is a scanner in conjunction with the tool box of FIG. 1 obtaining identification data of a server to be serviced.

FIG. 6 is the display of the tool box of FIG. 1 displaying a relevant portion of a user guide showing a way of removing a bracket of the server of FIG. 5.

FIG. 7 is a top view of a base of the tool box of FIG. 1.

FIG. 8 is a further top view of the base of the tool box of FIG. 7.

FIG. 9 is a sectional view of the tool box taken along line a-a of FIG. 8.

FIG. 10 is an exploded view of the base of the tool box of FIG. 7.

FIG. 11 is a diagram of the base of the tool box of FIG. 7 showing an order of use of two of the screwdriver bits in the base.

FIG. 12 is a diagram of possible operation of the lighting indicators in the base of the tool box of FIG. 7.

FIG. 13 is a flow chart of a smart learning process and a service training tool of the tool box of FIG. 7.

FIG. 14 is a diagram of one embodiment of a computer that may be included within the toolbox according to one embodiment.

### DETAILED DESCRIPTION

A tool box comprising a base having a tool storage area for removably storing a plurality of tools and a compartment below the tool storage area. The tool box further comprises a lid selectively securable to the base in a closed position to secure the plurality of tools and releasable to an open position that provides user access to the tools. Still further, the tool box comprises a processor and machine readable media storing instructions for performing a service operation with one or more of the tools, a data input device coupled to the processor, the data input device being for receiving identification data and providing the identification data to the processor, wherein the identification data identifies a target device upon which the service operation is to be performed, and an output device coupled to the processor for outputting at least a portion of the instructions to a user for servicing the target device.

The output device may, for example, be a speaker or display screen that is secured to the lid. The data input device may be, for example, selected from a radio frequency identification tag reader, a near field communication antenna, and a bar code scanner.

Embodiments of the tool storage area may include a plurality of receptacles, wherein each receptacle releasably secures a respective one of the tools. Furthermore, a plurality of indicator lights may be coupled to the processor for controlling the operation of each indicator light, where each indicator light is viewable in an area immediately adjacent a respective one of the plurality of receptacles. The indicator lights are preferably viewable when the lid is in the open position. In one option, each indicator light may include a light emitting diode secured to a printed circuit board within the compartment of the tool box and a light guide that directs light from the light emitting diode to the area immediately adjacent a respective one of the plurality of receptacles. The processor may control the operation of each of the indicator lights to independently and selectively present at least two lighting patterns. The tool box preferably further includes a machine readable memory coupled to the processor, wherein the machine readable memory is provided for storing the instructions, and the processor may activate an indicator light that is viewable immediately adjacent one of the tools identified in the portion of the instructions that is being output to the output device.

In a further embodiment, the tool box further includes a plurality of tool detectors coupled to the processor, where each tool detector is associated with one of the receptacles for indicating whether a tool is secured within one of the receptacles. In a related option, the tool box may further include a machine readable memory coupled to the processor, where the machine readable memory is provide for storing the instructions. The processor may monitor a tool detector that is associated with the receptacle securing one of the tools identified in the portion of the instructions that are being output to the output device, and the processor may maintain activation of the indicator light that is viewable immediately adjacent the receptacle for the identified tool until the identified tool has been removed and replaced.

Another embodiment provides a computer program product comprising non-transitory computer readable storage media having program instructions embodied therewith. The program instructions executable by a processor to: receive identification data through a data input device coupled to the processor, wherein the identification data identifies a target device upon which a service operation is to be performed; obtain instructions for performing the service operation on the identified target device; output at least a portion of the instructions to a user for servicing the target device; identify at least one tool that is identified in the portion of the instructions that is being output to the output device; and activate an indicator light that is viewable immediately adjacent one of a plurality of tools secured in a tool storage area of a tool box that incorporates the processor.

In various embodiments of the computer program product, the tool storage area includes a plurality of receptacles, and each receptacle is identified as securing a specific one of the tools. Accordingly, the program instructions may be further executable by the processor to control the operation of each of a plurality of indicator lights coupled to the processor, wherein each indicator light is viewable in an area immediately adjacent a respective one of the plurality of receptacles. In one option, the program instructions are further executable by the processor to independently control the operation of each indicator light to selectively present at least two lighting patterns during the service operation on the identified target device. In another option, the program instructions are further executable by the processor to activate an indicator light that is viewable immediately adjacent one of the tools identified in the portion of the instructions that is being output to the output device. The program instructions may be further executable by the processor to receive a signal indicating whether the identified tool is secured within a respective one of the receptacles, and maintain activation of the indicator light that is viewable immediately adjacent the receptacle for the identified tool until the identified tool has been removed and replaced. Still further, the program instructions may be further executable by the processor to measure a time duration over which the service operation on the target device is performed.

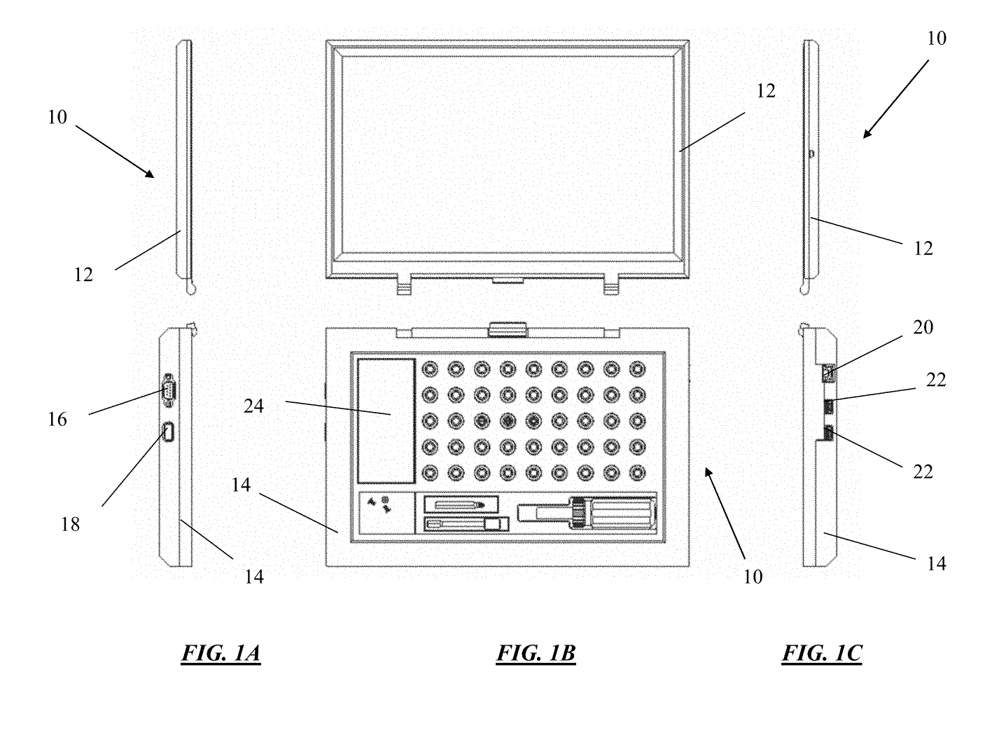

FIGS. 1A to 1C provide side and top views of a tool box 10 according to one embodiment. The tool box 10 includes a touch pad LCD display panel 12 and a base 14 which are in data communication with each other. The touch pad LCD display panel 12 and the base 14 may be fixedly engaged with and pivotable relative to each other and in data communication with each other via a data line, or are releasably engageable with each other and in data communication with each other wirelessly, such as through a Wi-Fi or Bluetooth® connection. However, wired or wireless communication may be implemented between the panel 12 and the base 14 regardless of the type of engagement there between. The tool box 10 may include a VGA socket 16, a communication socket 18, a LAN socket 20 a number of USB sockets 22, and an LCD display 24. The base 14 and/or the panel 12 is not required to include each of the elements 16, 18, 20, 22, 24 and the arrangement of these elements is not limited to the arrangement shown. However, as shown, the VGA socket 16 and communication socket 18 are disposed on a first side of the base 14, the LAN socket 20 and the USB sockets 22 are disposed on a second side of the base 14, and the LCD display 24 is disposed on the top of the base 14.

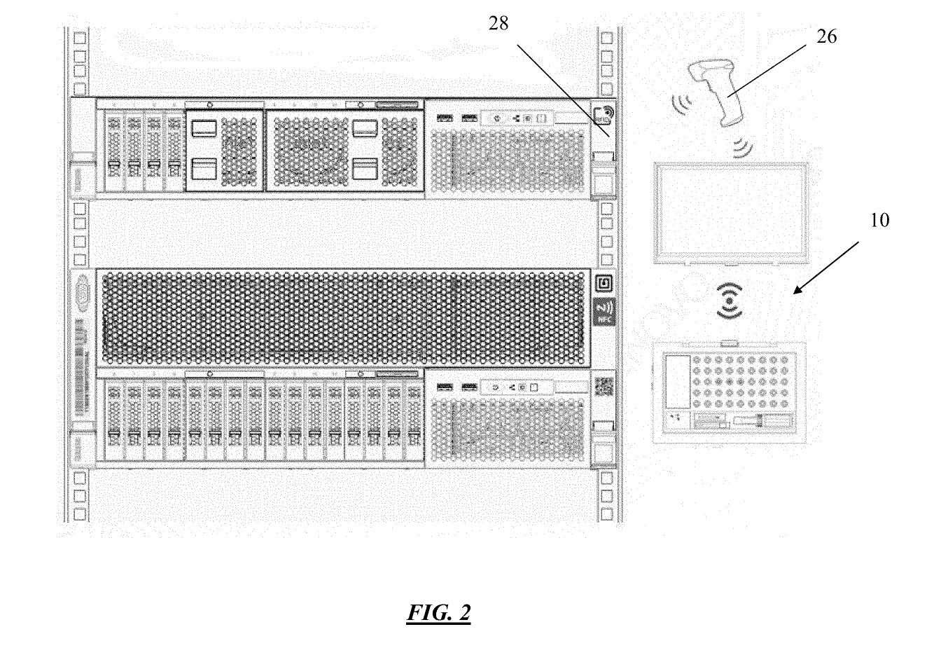

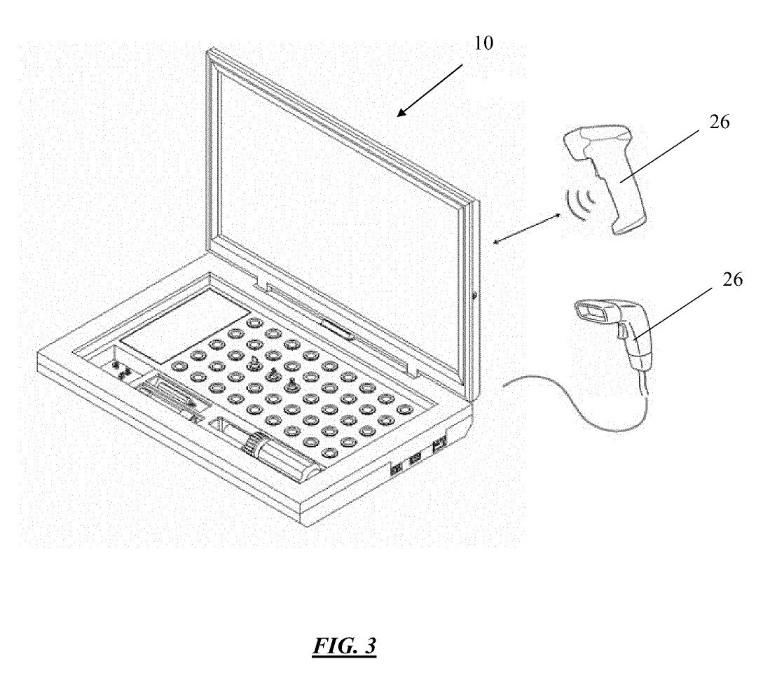

FIG. 2 is a diagram of a two-dimensional (2-D) code scanner 26 in data communication with the tool box 10 of FIG. 1. The scanner 26 may be in wireless data communication with the tool box 10, or, as shown in FIG. 3, the scanner 26 may be connected with the tool box 10 via a data line. In any event, the scanner 26 obtains identification data from a server 28 to be serviced or maintained by the user, and to transmit such identification data to the tool box 10. In particular, the scanner 26 may obtain such identification data from the server 28 by way of radio frequency identification (RFID) technology, near field contact (NFC) technology, or readable 2-D codes. Non-limiting examples of readable 2-D codes include Quick Response (QR) codes and barcodes, which may be printed on a label that is adhered to an accessible external surface of the server. Such identification data may comprise the manufacturer of the server, the model number of the server and/or other information about the server 28 that can be used to identify a user guide for the server.

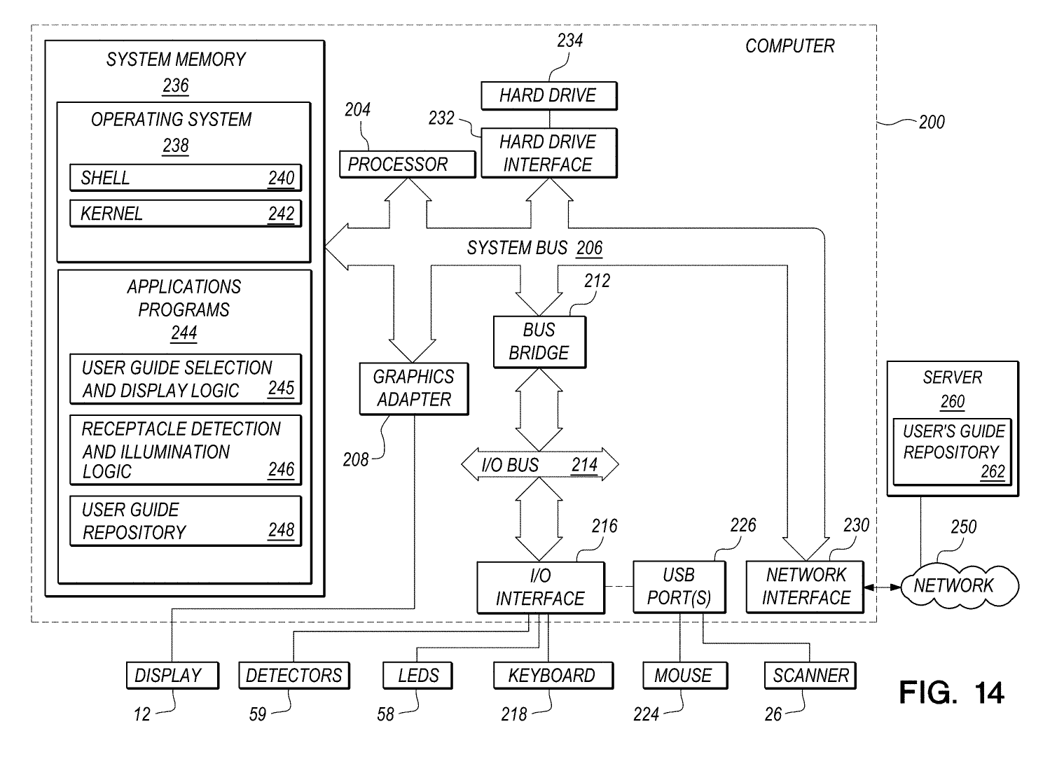

FIG. 14 is a diagram of one embodiment of a computer 200 that may be included within the toolbox 10 of FIGS. 1-3 according to one embodiment. The computer 200 includes a processor unit 204 that is coupled to a system bus 206. The processor unit 204 may utilize one or more processors, each of which has one or more processor cores. A graphics adapter 208, which drives/supports the display 12, is also coupled to system bus 206. The graphics adapter 208 may, for example, include a graphics processing unit (GPU). The system bus 206 is coupled via a bus bridge 212 to an input/output (I/O) bus 214. An I/O interface 216 is coupled to the I/O bus 214. The I/O interface 216 affords communication with various I/O devices, including a keyboard 218 (such as a touch screen virtual keyboard), and a USB mouse 224 via USB port(s) 226 (or other type of pointing device, such as a trackpad). As depicted, the computer 200 is able to communicate with other network devices over a network 250 using a network adapter or network interface controller 230. For example, the computer 200 may communicate with a remote server 260 that stores a repository of user guides 262 for any number of servers 28 that may be desired to be serviced. If the computer 200 does not store the user guide needed to service a server 28, then the needed user guide may be downloaded from the remote server 260.

A hard drive interface 232 is also coupled to the system bus 206. The hard drive interface 232 interfaces with a hard drive 234. In a preferred embodiment, the hard drive 234 communicates with system memory 236, which is also coupled to the system bus 206. System memory is defined as a lowest level of volatile memory in the computer 200. This volatile memory includes additional higher levels of volatile memory (not shown), including, but not limited to, cache memory, registers and buffers. Data that populates the system memory 236 includes the operating system (OS) 238 and application programs 244.

The hardware elements depicted in the computer 200 are not intended to be exhaustive, but rather are representative. For instance, the computer 200 may include non-volatile memory and the like.

The operating system 238 includes a shell 240 for providing transparent user access to resources such as application programs 244. Generally, the shell 240 is a program that provides an interpreter and an interface between the user and the operating system. More specifically, the shell 240 executes commands that are entered into a command line user interface or from a file. Thus, the shell 240, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. Note that while the shell 240 may be a text-based, line-oriented user interface, embodiments may support other user interface modes, such as graphical, voice, gestural, etc.

As depicted, the operating system 238 also includes the kernel 242, which includes lower levels of functionality for the operating system 238, including providing essential services required by other parts of the operating system 238 and application programs 244. Such essential services may include memory management, process and task management, disk management, and mouse and keyboard management.

As shown, the computer 200 includes application programs 244 in the system memory of the computer 200, including, without limitation, a user guide selection and display logic module 245, a receptacle detection and illumination logic module 246 and a local user guide repository 248 in order to implement one or more of the embodiments disclosed herein. Optionally, one or more of these modules 245, 246, 248 may be included in the operating system 238.

Accordingly, the tool box 10 that includes the computer 200 may include a machine readable memory which may store user guides of a number of servers which may be serviced by using the tools in the tool box 10. Upon receipt of the identification data of the server 28 through the scanner 26 (on manually input through a keyboard or voice command), the processing unit 204 (or called a “processor”) of the tool box 10 accesses the machine readable memory 236 and reads from the relevant user guide of the server 28 that is identified by the identification data, such that the display panel 12 may then display one or more portions of the relevant user guide of the identified server 28.

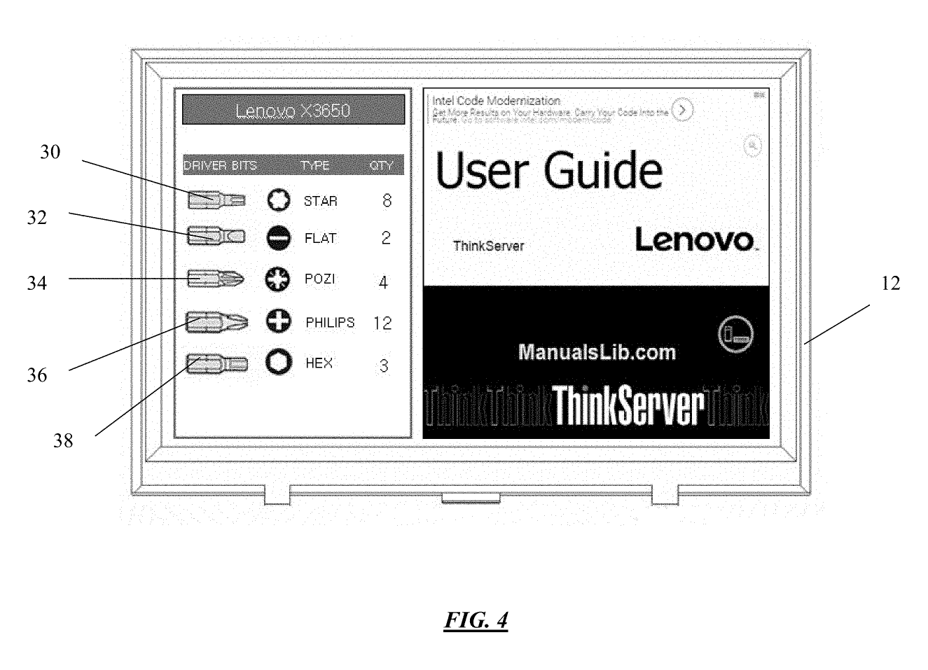

FIG. 4 illustrates the display panel 12 of the tool box 10 of FIG. 1 displaying a user guide of an identified server to be serviced. In particular, the LCD display panel 12 displays instructions, such as a sequence of use of the various kinds of screwdriver bits 30, 32, 34, 36, 38 for servicing the server 28 of FIG. 2 and the number of corresponding screws that each of the respective screwdriver bits are to unscrew and to subsequently screw back. For example, to service the specific model of server 28 whose user guide is shown in the LCD display panel 12 of the tool box 10, a star screwdriver bit is required for unscrewing (and subsequently screwing back) eight star screws, a flat screwdriver bit is required for unscrewing (and subsequently screwing back) two flat screws, a pozi screwdriver bit is required for unscrewing (and subsequently screwing back) four pozi screws, a philips screwdriver bit is required for unscrewing (and subsequently screwing back) twelve philips head screws, and a hex screwdriver bit is required for unscrewing (and subsequently screwing back) three hex screws. Optionally, the size of the bit might also be displayed if different size bits are needed.

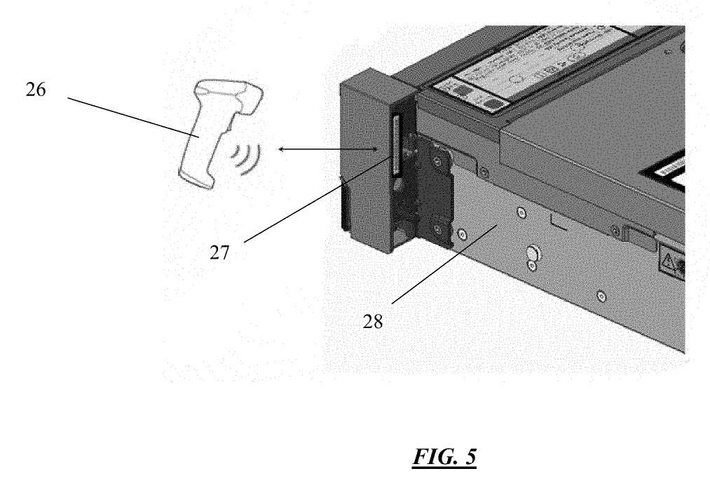

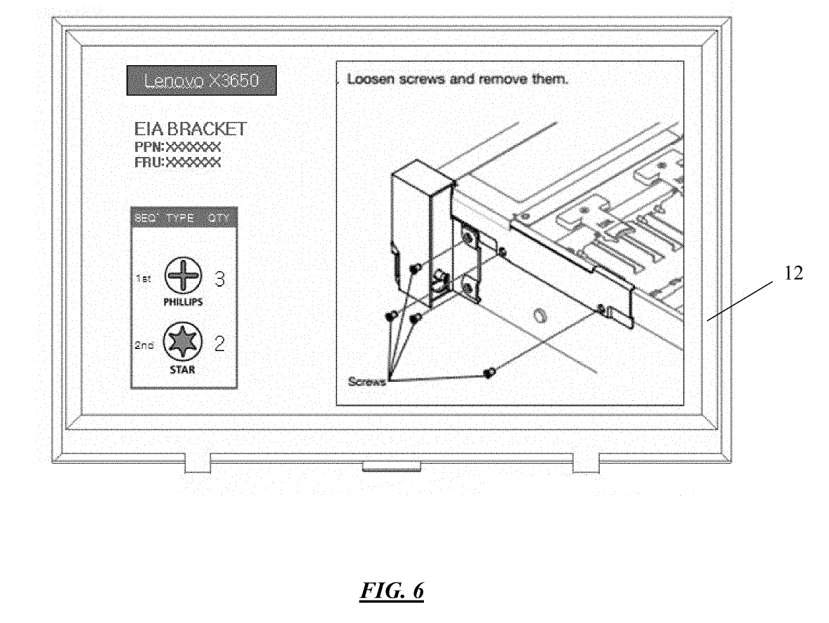

Additionally, in order to service an identified server it may be necessary to install parts to or remove parts from the server 28. In one embodiment, upon scanning of printed identification data, such as the barcode 27, disposed on an accessible surface of the server 28 as shown in FIG. 5, the relevant identification data is transmitted to the processor of the tool box 10 such that the tool box 10 may display relevant drawings, diagrams or instructions on its LCD display 12. In the example of FIG. 6, the display may show a drawing or diagram that shows the position of the screws which are required to be unscrewed for purpose of servicing (i.e., installation, removal, upgrade and/or repair) of a part, and the number of different types of screws involved.

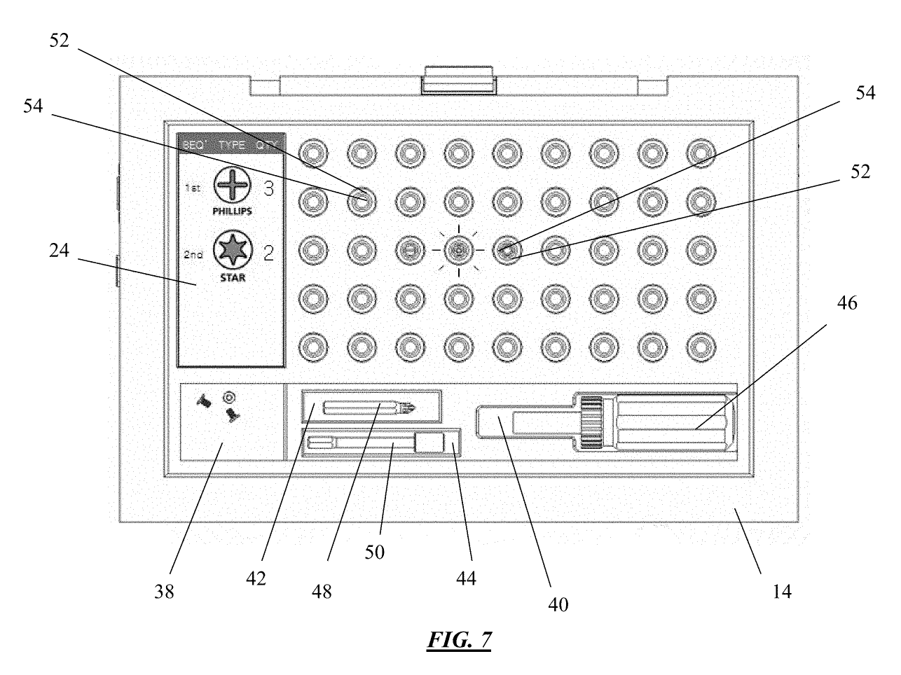

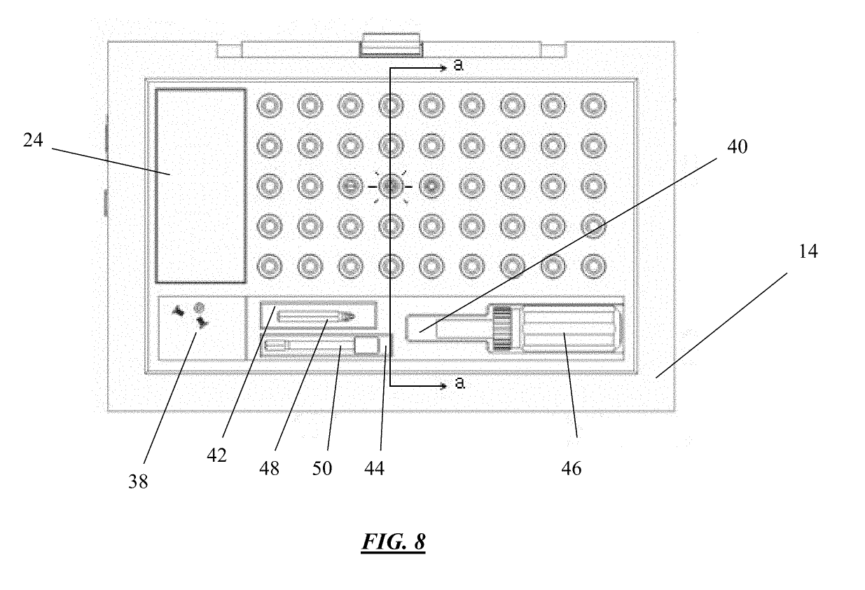

FIGS. 7 and 8 are top views of a base 14 of the tool box 10 of FIG. 1. As shown, the base 14 includes a plurality of cylindrical receptacles 52 each for releasably receiving a respective screwdriver bit 54 differing from one another in shape and/or size. The base 14 may also include an LCD display screen 24, a parts receptacles 38 and various tool receptacles 40, 42, 44 for receiving a tool 46, 48, 50, respectively. In one example, assume that, for the purpose of servicing the server 28, three Phillips screws are to be unscrewed from the server 28 and then two Star screws are to be unscrewed from the server 28. Such details (including the shape of the screws) are displayed on the LCD display 24 in the base 14 of the tool box 10. In addition to the LCD display 24, the base 14 of the tool box 10 may also include a receptacle 38, e.g. for receiving screws that have been removed from the server 28 being serviced, and receptacles 40, 42, 44 for receiving various tool parts. For example, the receptacle 40 may releasably receive a screwdriver handle 46, the receptacle 42 may releasably receive a screwdriver bit 48, and the receptacle 44 may releasably receive an extension part 50 which may be releasably engaged with the screwdriver handle 46.

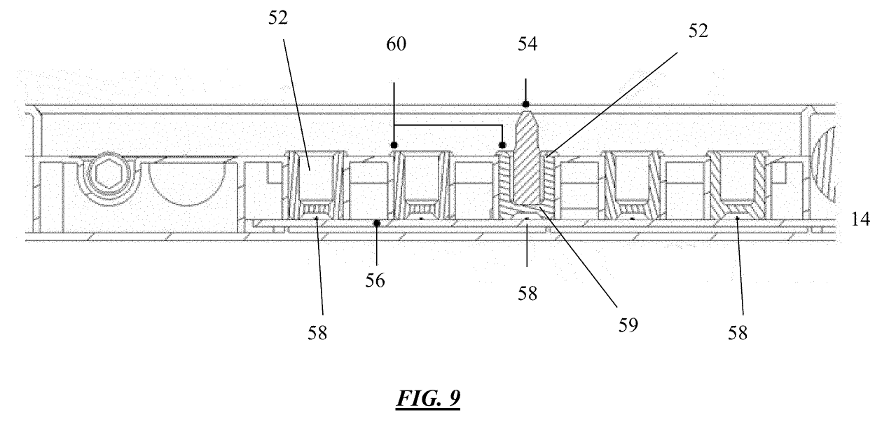

FIG. 9 is a sectional view of the tool box base 14 taken along line a-a of FIG. 8. In the embodiment shown, the base 14 includes a printed circuit board (PCB) 56 (control board) to which a number of light-emitting diodes (LEDs) 58 are installed or formed. Light from the LEDs 58 is able to be transmitted by a light guide 60 to direct light from one of the LEDs to an upward facing surface of the base 14 so that a user can see the light adjacent to a screwdriver bit received in a receptacle 52 of the base 14. For example, the light guide 60 may be made with a translucent material and may form an annular ring surrounding a respective cylindrical receptacle 52. It can be seen from FIG. 9 that when a screwdriver bit 54 is received within a receptacle 52, light from the LED 58 below the receptacle 52 may be directed through the light guide 60 to be perceivable and viewable along the top of the base 14. In one embodiment, the light guide 60 forms an annular pattern surrounding the receptacle 52.

The PCB 56 may further include or connect with an array of detectors 59, each detector being positioned to detect the presence or absence of a screwdriver bit 54 within one of the receptacles 52. Such a detector 59 may be a conductivity sensor, light sensor or physical switch that provides a distinct signal when the screwdriver bit is present in the receptacle. By providing a detector 59 with each receptacle 52, the processor 204 is able to determine the receptacle from which a screwdriver bit has been removed and/or replaced.

In use, once the server 28 to be serviced is identified (e.g. by the scanner 26 obtaining the relevant identification data from a barcode on an outside surface of the server 28), the corresponding user guide stored in memory of the tool box 10 is displayed by the touch pad display panel 12, with the screw types, quantity of screws involved, and service order (and possibly even with a video) displayed by the display panel 12. The LCD display 24 and the LEDs 58 are also used in a manner to assist a user in quickly identifying and locating the needed screwdriver bit(s) 54.

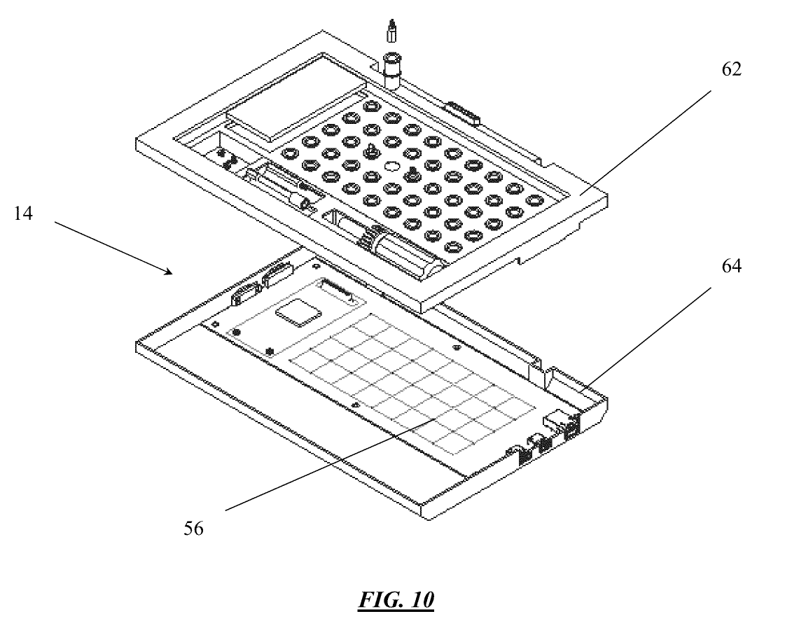

FIG. 10 is an exploded perspective view of the base 14 of the tool box 10 of FIG. 7. In this example, the base 14 may include an upper case portion 62 and a lower case portion 64 that are engageable and securable with each other. The PCB control board 56 may be fixed to the lower case portion 64 and include an array of the LEDs 58 of FIG. 9, as well as many of the components of the computer 200 of FIG. 14 and the elements 16, 18, 20, 22, 24 of FIGS. 1A and 1C.

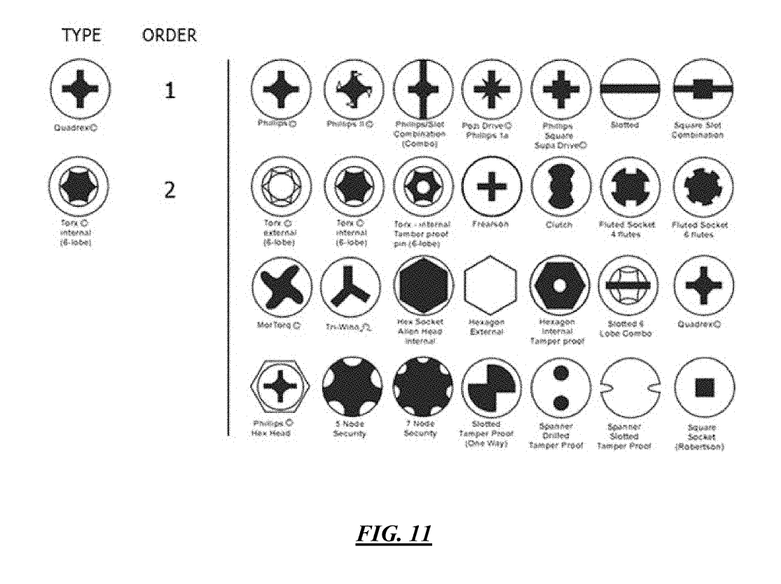

FIG. 11 is a diagram of the base 14 of the tool box 10 of FIG. 7 showing an example of an order of use of two of the screwdriver bits in the base. It is assumed here that servicing of a certain server 28 requires use of a Quadrex type screwdriver bit and then an Internal 6-lobe screwdriver bit. The order of use of these two types of screwdriver bits is shown by the LCD display 24 (shown on the left side) and may also be displayed by the touch pad display panel 12 of FIG. 4. The annular area surrounding the cylinder receptacle 52 that contains the Quadrex type screwdriver bit and the annular area surrounding the cylindrical receptacle 52 that contains the Internal 6-lobe screwdriver bit may be controlled to light up by the respective LEDs 58 that are aligned beneath the receptacles 52. In one option, the light guide associated with the cylinder receptacle 52 containing the Quadrex type screwdriver bit may be controlled to flash on and off, whereas the light guide associated with the cylindrical receptacle 52 containing the Internal 6-lobe screwdriver bit may be controlled to light up continuously on, thus signifying that the Quadrex type screwdriver bit is the first screwdriver bit to be used and the Internal 6-lobe screwdriver bit is the second screwdriver bit to be used in accordance with the order or sequence of use of the various screwdriver bits 54 indicated by the user guide for identified server 28. Cylindrical receptacles 52 containing screwdriver bits 54 that are not required in the servicing of the server 28 in question may not have their associated light guide lit up.

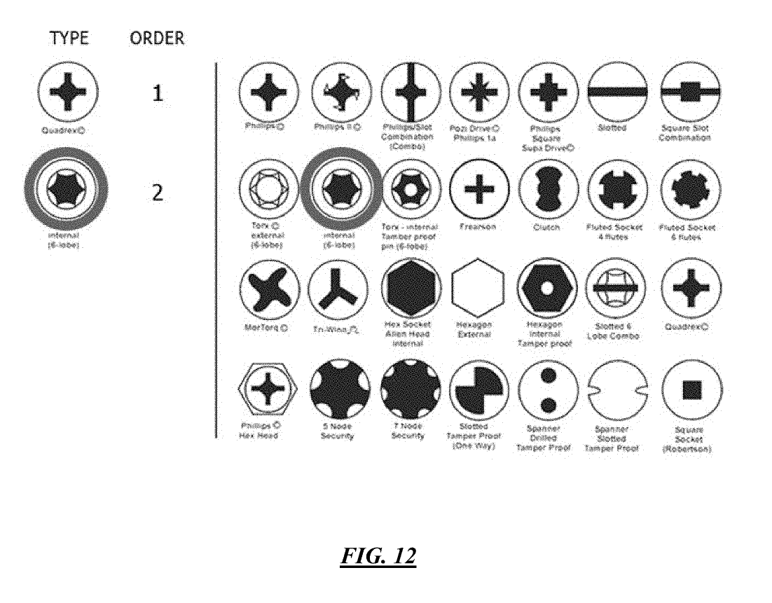

FIG. 12 is a diagram of one embodiment of possible operation of the lighting indicators (i.e., an LED/light guide combination) in the base 14 of the tool box of FIG. 7. In this embodiment, after a user removes the correct screwdriver bit 54 (e.g. the Quadrex type screwdriver bit in the present example), the relevant LED 58 whose light is aligned with and illuminates the light guide adjacent or surrounding the relevant receptacle 52 may continue to flash until the screwdriver bit 54 that was removed has been returned to the relevant receptacle 52. The LED 58 for illuminating the light guide adjacent or surrounding the receptacle 52 containing the screwdriver bit 54 to be used next in servicing the server 28 (e.g. the Internal 6-lobe screwdriver bit in the present example) may then flash, signifying that this is the next screwdriver bit 54 in the order or sequence to be used, as shown in FIG. 12. Thus, each LED 58 can independently controlled to present at least two lighting patterns.

If, on the other hand, the user retrieves an incorrect screwdriver bit 54 in the course of servicing the server 28, all the LEDs 58 may be controlled to turn on simultaneously, thus causing all the light guides adjacent or surrounding all of the receptacles 52 to illuminate simultaneously in order to act as an alert to the user that an incorrect screwdriver bit 54 has been retrieved. The user should then return the incorrectly-retrieved screwdriver bit 54 back to the corresponding receptacle 52. Then, the LED 58 for illuminating the light guide adjacent or surrounding the receptacle 52 containing the next correct screwdriver bit 54 to be used may flash, whereas the LED(s) 58 for illuminating the light guide adjacent or surrounding the receptacle(s) 52 containing the subsequent screwdriver bit(s) 54 to be used subsequently may light up continuously. Optionally, the machine readable memory in the tool box 10 may also store data relating to the times and/or frequency of use of each of the screwdriver bits 54 in the tool box 10.

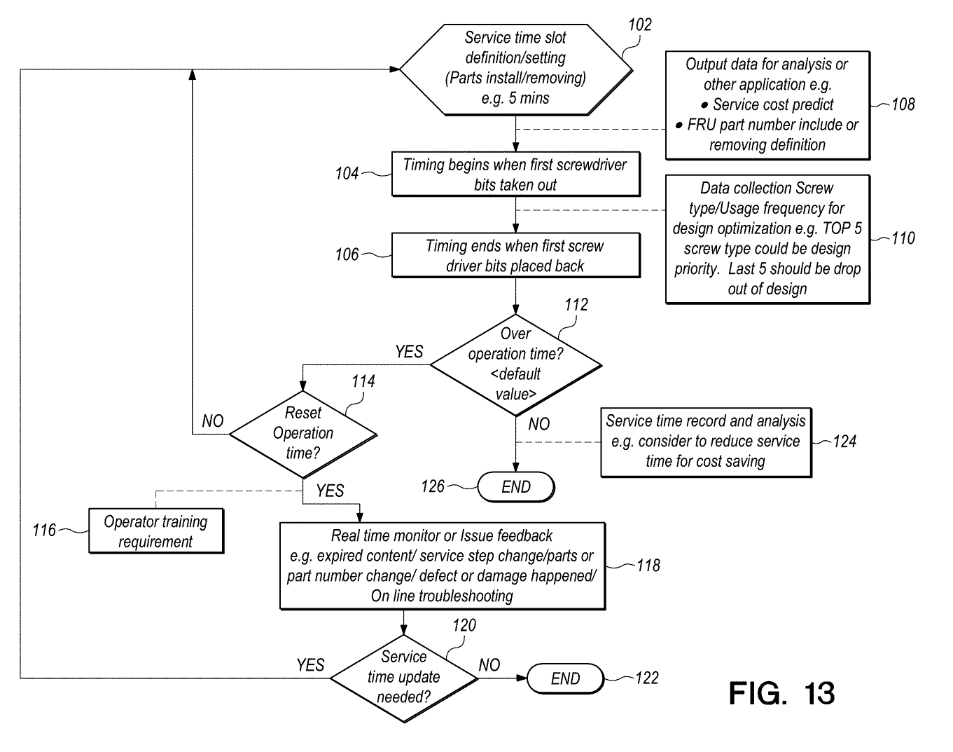

FIG. 13 is a flow chart of an exemplary smart learning process and a service training tool according to an embodiment. According to this method, a service time slot definition/setting is carried out for performing a service task. For example, the service task may be installing a certain part to and/or removing a certain part from the server 28 (Step 102), and a service time slot of 5 minutes may be set. Timing may commence in response to removal of a first screw driver bit (Step 104) from a receptacle of the tool box 10, which may be triggered by a signal from the detector 59 (see FIG. 9) associated with the receptacle where the screwdriver bit is removed. Timing may end in response to replacing the first screw driver bit back into the receptacle of the tool box 10 (Step 106), which may be triggered by a signal from the detector 59 associated with the receptacle where the screwdriver bit is replaced. After Step 102, the tool box 10 may output data for analysis or other applications (Step 108), such as for prediction of a servicing cost, or the inclusion or removal of a field-replaceable unit (FRU) part number definition. After Step 104, the tool box 10 may perform data collection (Step 110), such as collecting data representing the type(s) of screw(s) used or usage frequency. For example, the data collection may support future design optimization, such as the top five most used screw types could be included with priority in designs, whereas the five least used screw types may be dropped from the designs.

If Step 112 determines that the actual service/operation time duration is longer than the service time slot that was set/defined in Step 102, then Step 114 determines whether the service time slot is to be re-set. If the time slot is not re-set, then the method returns to Step 102. If, however, the service time slot is re-set (Step 114), then the operator may require further training (Step 116) and a real time monitor may be carried out or feedback may be issued (Step 118). For example, such feedback may reflect expired content, a change in the service step, a change in the part or part number, or that defect or damage has occurred, or online troubleshooting is carried out. After Step 118, a decision is made (Step 120) as to whether a service time update is required. If not, the process may end (Step 122). If a service time update is required (Step 120), service time slot setting/definition (Step 102) may be carried out again. If Step 112 determines that the service/operation time duration is not longer than the time slot set/defined in Step 102, then the service time is recorded and analyzed (Step 124), e.g. for considering how it may be possible to reduce the service time for cost reduction. The process may then end (Step 126), until a next screw driver bit is taken out from the tool box 10, whereupon Step 102 commences again.

According to a further embodiment, a method of operating the tool box 10 involves: scanning an RFID/NFC tag of the server 28 by the scanner 26 to obtain identification data and providing the identification data to the tool box 10; and scanning a QR code displayed on the server 28 to obtain error-related data and providing the error-related data to the tool box 10.

By way of such an arrangement, the relevant part of the relevant user guide can be provided to the data center technician via the tool box display 12, thereby enabling the technician to rectify a specific problem of the server 28. Otherwise, the user guide is provided to the technician “as is”, regardless of the specific problem of the server 28.

It should be noted that although an embodiment has thus far been discussed in the context of being suitable for servicing and/or maintaining servers, it is envisaged that such may be used for servicing and/or maintaining other machines and apparatus, e.g. televisions, washing machines, etc. In addition, although an embodiment has thus far been discussed in the context in which the receptacles 52 are for releasably containing screwdriver bits 54 of different shapes and/or sizes, it is envisaged that different types of tools may be releasably contained within the receptacles 52. For example, the base 14 of the tool box 10 may contain receptacles of different shapes for receiving different tools, e.g. pliers, scissors, screwdrivers, soldering devices etc. Thus, the words “tool” and “tools” in the specification and claims should be construed broadly to cover both tools and tool parts.

In addition, although an embodiment has thus been discussed in the context in which instructions (user guide) for servicing and/or maintaining servers are provided visually, it is envisaged that such user guide may be issued audibly. Furthermore, a user guide may provide information that involves a “tool-less” method of servicing and/or maintaining the computer servers.

It should be understood that the above only illustrates and describes an example whereby an embodiment may be carried out, and that modifications and/or alterations may be made thereto. It should also be understood that certain features of the embodiments, which are, for brevity, described in the context of a single embodiment, may also be provided separately or in any suitable sub-combination.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A tool box, comprising:
a base having a tool storage area for removably storing a plurality of tools and a compartment below the tool storage area;
a lid selectively securable to the base in a closed position to secure the plurality of tools and releasable to an open position that provides user access to the tools;
a processor and machine readable media storing instructions for performing a service operation with one or more of the tools;
a data input device coupled to the processor, the data input device being for receiving identification data and providing the identification data to the processor, wherein the identification data identifies a target device upon which the service operation is to be performed; and
an output device coupled to the processor for outputting at least a portion of the instructions to a user for servicing the target device.

2. The tool box of claim 1, wherein the output device is a display screen that is secured to the lid.

3. The tool box of claim 1, wherein the output device is a speaker.

4. The tool box of claim 1, wherein the data input device is selected from a radio frequency identification tag reader, a near field communication antenna, and a bar code scanner.

5. The tool box of claim 4, wherein the tool storage area includes a plurality of receptacles, wherein each receptacle releasably secures a respective one of the tools, the tool box further comprising:
a plurality of indicator lights coupled to the processor for controlling the operation of each indicator light, each indicator light viewable in an area immediately adjacent a respective one of the plurality of receptacles, wherein the indicator lights are viewable when the lid is in the open position.

6. The tool box of claim 5, wherein each indicator light includes a light emitting diode secured to a printed circuit board within the compartment and a light guide that directs light from the light emitting diode to the area immediately adjacent a respective one of the plurality of receptacles.

7. The tool box of claim 5, wherein the processor controls the operation of each of the indicator lights to independently and selectively present at least two lighting patterns.

8. The tool box of claim 5, further comprising:
a machine readable memory coupled to the processor, the machine readable memory for storing the instructions, and the processor for activating an indicator light that is viewable immediately adjacent one of the tools identified in the portion of the instructions that is being output to the output device.

9. The tool box of claim 8, further comprising:
a plurality of tool detectors coupled to the processor, each tool detector associated with one of the receptacles for indicating whether a tool is secured within one of the receptacles.

10. The tool box of claim 9, further comprising:
a machine readable memory coupled to the processor, the machine readable memory for storing the instructions, the processor for monitoring a tool detector that is associated with the receptacle securing one of the tools identified in the portion of the instructions that are being output to the output device, and the processor for maintaining activation of the indicator light that is viewable immediately adjacent the receptacle for the identified tool until the identified tool has been removed and replaced.

11. A computer program product comprising non-transitory computer readable storage media having program instructions embodied therewith, the program instructions executable by a processor to:
receive identification data through a data input device coupled to the processor, wherein the identification data identifies a target device upon which a service operation is to be performed;
obtain instructions for performing the service operation on the identified target device;
output at least a portion of the instructions to a user for servicing the target device;
identify at least one tool that is identified in the portion of the instructions that is being output to the output device; and
activate an indicator light that is viewable immediately adjacent one of a plurality of tools secured in a tool storage area of a tool box that incorporates the processor.

12. The computer program product of claim 1, wherein the at least a portion of the instructions are output to a display screen coupled to the processor.

13. The computer program product of claim 1, wherein the at least a portion of the instructions are the output to a speaker coupled to the processor.

14. The computer program product of claim 1, wherein the data input device is selected from a radio frequency identification tag reader, a near field communication antenna, and a bar code scanner.

15. The computer program product of claim 1, wherein the tool storage area includes a plurality of receptacles, and wherein each receptacle is identified as securing a specific one of the tools.

16. The computer program product of claim 15, wherein the program instructions are further executable by the processor to:
control the operation of each of a plurality of indicator lights coupled to the processor, wherein each indicator light is viewable in an area immediately adjacent a respective one of the plurality of receptacles.

17. The computer program product of claim 16, wherein the program instructions are further executable by the processor to:
independently control the operation of each indicator light to selectively present at least two lighting patterns during the service operation on the identified target device.

18. The computer program product of claim 16, wherein the program instructions are further executable by the processor to:
activate an indicator light that is viewable immediately adjacent one of the tools identified in the portion of the instructions that is being output to the output device.

19. The computer program product of claim 18, wherein the program instructions are further executable by the processor to:
receive a signal indicating whether the identified tool is secured within a respective one of the receptacles; and
maintain activation of the indicator light that is viewable immediately adjacent the receptacle for the identified tool until the identified tool has been removed and replaced.

20. The computer program product of claim 19, wherein the program instructions are further executable by the processor to:
measure a time duration over which the service operation on the target device is performed.
